(19) United States
(12) Patent Application Publication
(10) Pub. No.: US 2025/0307952 A1
(43) Pub. Date: Oct. 2, 2025

(54) SYSTEMS AND METHODS TO CONTROL POLARIZATION ON SOCIAL MEDIA PLATFORMS

(71) Applicant: Adeia Guides Inc., San Jose, CA (US)

(72) Inventor: Jean-Yves Couleaud, Mission Viejo, CA (US)

(21) Appl. No.: 18/617,175

(22) Filed: Mar. 26, 2024

(51) Int. Cl. G06Q 50/00

(52) U.S. Cl. CPC G06Q 50/01

(57) ABSTRACT

Methods and systems are described for control of polarization including generation of a suggested response to a social media post. A social media post is received from a device associated with a user. A first taxonomy of the post's textual information and a second taxonomy for a connected user account are determined. The first and second taxonomies and a predetermined condition are compared. A response intended for the connected user account is generated with a third taxonomy similar to the second taxonomy based on the comparison. Related apparatuses, devices, techniques, and articles are also described.

### FIELD OF THE DISCLOSURE

The present disclosure relates to content generation, personalization, and recommendations.

### SUMMARY

Trust in social media is undermined by misinformation and fake news. Despite legislation, especially in the European Union (EU), requiring social media platforms to combat hate speech and disinformation, the task is challenging. It demands a large number of reviewers or a highly efficient automated process. Often, by the time inappropriate content is detected, it has already proliferated across various platforms, making efficient removal difficult. Some platforms, like X (formerly Twitter), have introduced user-generated “community notes” to provide additional context to posts; however, these tools have limited visibility, require consensus, are subject to algorithm bias, are ineffective against misinformation, and create potential for negative content.

Polarization on various topics is believed to drive engagement among the most polarized individuals, excluding a large portion of users from balanced social networks like Facebook or X. These networks, compared to niche networks like Parler or Rumble, offer a greater diversity of opinions. Regardless, users across these platforms experience a filter bubble, i.e., a state of intellectual isolation that can result from personalized searches, recommendation systems, and algorithmic curation inherent to the platforms.

In one approach, automated detection and removal of inappropriate content is provided but proven inefficient in combating polarization.

In the United States, defenders of the First Amendment argue that suppressing inappropriate content is an attack on Free Speech. In the EU, despite heavy legislation on hate speech, regulating it on social media has been challenging. While Germany has passed a law requiring operators to remove hate speech and disinformation within a week, similar laws in France have been deemed unconstitutional. Other approaches involve detecting inappropriate content and then limiting or eliminating its visibility on the platform.

While removal of inappropriate content can effectively eliminate a single post, it is not efficient in combating overall polarization. Similar posts or variations may be generated shortly after one has been removed. Moreover, expressing polarizing views is often not illegal, and social media platforms are not obligated to act on posts sharing these views, preferring to maintain the status quo.

Comment bots, which can be purchased to artificially boost viewership, exist today. This further contributes to the challenges faced by social media platforms in managing content and user engagement.

To help address the limitations and problems of these and other approaches, methods and systems are provided to encourage users sidelined by social media platforms to participate in more balanced discussions, even on polarizing subjects. As a result, engagement is increased. Also, the filter bubble problem is minimized.

Methods and systems are provided to combat extreme polarization. For example, an author of a polarizing post with an extreme position is encouraged to consider a more balanced opinion. In some embodiments, a device associated with a user is presented with a suggestion for a response to a polarizing post. As used herein, the term “response” is not intended to be limiting and includes any of a wide variety of communications on social and digital media platforms including at least one of a reply to the original post, a post that references the original post, a comment, a share, a retweet, a mention, a tag, a status update, a reaction, a thread, a hashtag, a poll, combinations of the same, or the like. An artificial intelligence (AI) agent or assistant may generate the suggestion. The suggestions may be automatically disseminated across a network. The suggestions may be distributed to targeted audiences predicted to balance the discussion. The user may be prompted to confirm a suggestion before distribution. Also provided are semiautonomous and fully autonomous methods and systems in which AI agents are configured to respond to polarizing posts showing extreme positions on behalf of a user or the platform itself.

In the following, the use of the term “polarizing” is intended to be broad unless characterized in particular embodiments or examples. Polarizing content may include content for which extreme opposite views are present on a given network.

In some embodiments, a set of AI agents generate comments on a post that a device associated with a user has just made in order to orient discussion in a less polarized direction. For example, the AI feedback is configured to orient an active post, argument, or discussion so that an original poster realizes that moderate, alternate and/or opposite views are shared by others. If the original poster repeatedly comes to such realization, the original poster is disincentivized from sharing similarly polarized content in the future (i.e., a “peer pressure” effect).

In some embodiments, autonomous AI agents are configured to generate comments based on a semantic analysis of an original post and a subject orientation guide that mimic a heated debate between two or more users. The semantic analysis of the post may provide identification of basic sentence structure, subjects, topics, sub-topics, combinations of the same, or the like. In another example, the AI agents act on behalf of a user with whom the original poster is connected by suggesting to that user a comment to add to the original poster's post that would reinforce the power of the message. Such approaches leverage “social proof,” the general principle that people tend to conform to actions and beliefs of their social group, especially when they are uncertain (i.e., a “better peer pressure” effect).

In some embodiments, AI agents are configured to evaluate a relevance of a user's position regarding an original post before selecting that user for suggesting a response to the original post. Once a user has accepted, via a device associated with the user, the suggestion from the AI agent, in some embodiments, other AI agents reinforce that user's response by suggesting additional reinforcement responses to other users who share similar positions.

By utilizing the methods and systems disclosed herein, social media platforms benefit from a “softer” way to deal with polarizing content as compared to the approaches described above. Even if it is true that polarizing content drives engagement amongst a polarized audience, it is also important to recognize that a larger part of the audience includes non-polarized users. By recentering discussions with the present methods and systems (instead of letting them wander into the extremes), social media platforms are able to engage a broader audience. Engagement of a broader audience improves reach, visibility, and revenue streams, such as advertisement revenues.

Throughout the disclosure, examples are provided in which a post or message is analyzed to quantify or otherwise characterize the post in computer-implemented terms that represent the meaning of the post. The analyzing can be achieved using, for example, any suitable form of computational linguistics. Computational linguistics includes, for example, at least one of natural language understanding, natural language generation, information retrieval, text mining, sentiment analysis, topic modeling, named entity recognition, language detection, keyword extraction, combinations of the same, or the like.

In some embodiments, a post is received, content of the post is analyzed to determine a taxonomy, the taxonomy of other connected accounts is identified, the taxonomies are compared to a set condition, and a response is generated that aligns with the taxonomy of the other accounts if the condition is met.

In some embodiments, a taxonomy is defined by a platform to describe activity occurring on the platform. For example, the taxonomy includes information such as whether a post is about a particular subject (e.g., dogs, cats, politics, weather, and the like). Then, for example, a representation or an embedding, such as a taxonomy vector, is computed for a taxonomy associated with a post. Generally, the taxonomy vector represents a value of the post in a space defined by the taxonomy. For example, a post about dogs may have a taxonomy vector of (1,0,0,0,0) in the space; whereas, a post about cats being anxious when it rains may have an associated taxonomy vector of (0,1,0,0,0.5) in the space. The embedding may include, in some embodiments, at least one of word embeddings, sentence embeddings, document embeddings, graph embeddings, contextualized embeddings, combinations of the same, or the like.

In some embodiments, polarization in social media is controlled. For example, a social media post is received from a device associated with a user. A taxonomy for the post and for a connected user is determined. These taxonomies and a predetermined condition are compared. If the comparison satisfies the condition, a response may be generated. This response has a taxonomy within a range of the connected user's taxonomy.

In some embodiments, the taxonomies are scored, e.g., along a linear scale representing various positions on a topic of the social media post. The taxonomy of a post is determined using a machine learning model trained for this purpose.

In some embodiments, a machine learning model is configured to receive word vectorization of the post and output a taxonomy vector, where each component is associated with a score in a thematic category. For example, taxonomies are compared using Euclidean distance, with a condition satisfied if the distance exceeds a polarization threshold. For example, taxonomies are compared using cosine similarity, with a condition satisfied if the similarity is less than a polarization threshold.

In some embodiments, a polarization score is provided. The polarization score can be used to quantify the polarizing nature of content. The polarization scores can be used as part of the taxonomy and/or the linear scale. For example, the polarization score represents how much user preferences for a subject or viewpoint differ from an average user preference for the subject or viewpoint.

In some embodiments, a connected user account is selected from multiple accounts. For example, a subset of the second taxonomy is determined by eliminating components of the first taxonomy. The first taxonomy and the subset of the second taxonomy are compared.

In some embodiments, if the difference between the first and second taxonomy exceeds a polarization threshold, an AI agent is queried to generate responses. Responses are ordered by distance or similarity to the second taxonomy. The closest response is selected. The polarization threshold can be defined by the social media platform. The polarization threshold can also be defined by a user-selectable setting of the second user account. The polarization threshold can be defined by a machine learning model trained on engagement data from one or more social media posts having content associated with the first taxonomy or the second taxonomy.

In some embodiments, interaction levels are determined between the first user account and multiple second user accounts. The one with the highest interaction is selected. The response is transmitted to the selected one.

In some embodiments, a digital twin model is trained for each user account. For example, these models are tuned using a large language model and content posted by each user account. The tuned model is used to generate the response.

In some embodiments, the response is transmitted to the second user account for pre-approval before posting. For example, when the second user account posts the response, a user account is identified that is determined to be a good candidate for inclusion. For example, taxonomies of posts of the user account are quantified, averaged, and compared to the taxonomy of the post and/or the response. The user account with a similar taxonomy is identified. The response is transmitted to the identified user account for pre-approval, and the response is posted upon approval. This process can be repeated for multiple user accounts having a relationship with the first user account and/or the second user account. Also, in some embodiments, a position profile (detailed herein) of a particular user account is determined based on, for example, the taxonomies of the posts of the user account.

In some embodiments, if the second user account begins a manual response, the response is transmitted for pre-approval. For example, the manual response is replaced with the response upon approval.

In some embodiments, a model is trained for an automated AI agent to generate the response. For example, the AI agent model is trained to orient a discussion in a less polarized, more polarized, or centrist direction. Also, for example, the AI agent model is trained to generate the response in a style of a heated debate, a particular person, a celebrity, or an influencer.

In some embodiments, an appropriate time for the response is determined based on the post time and interaction time by another user account.

In some embodiments, the response is provided as part of a graphical user interface (GUI) that includes the post, response, and a field for manual input. For example, the GUI includes an option for inserting the response into the field. Also, for example, the GUI includes an option for editing the response before insertion. Further, for example, the GUI includes an option for refusing to post the response.

In some embodiments, a GUI is generated with options for changing parameters for generating the response.

In some embodiments, if the post includes audio, the audio is analyzed with a speech-to-text converter, and the text from the same is added to the information of the social media post. In some embodiments, if the post includes an image, the image is analyzed with an object identifier, and the result of the analysis is added to the information of the social media post. In some embodiments, if the post includes an image, the image is analyzed with an image-to-text analyzer, and the result of the analysis is added to the information of the social media post. In some embodiments, if the post includes an image, the image is analyzed with an optical character reader to detect text in the image, and the detected text from the same is added to the information of the social media post.

Also provided is a system with control circuitry configured to perform one or more of the above-referenced features. Further provided is a device equipped with means for performing one or more of the above-referenced features. Still further provided is a non-transitory, computer-readable medium with instructions that, when executed, perform one or more of the above-referenced features. Related apparatuses, devices, techniques, and articles are also provided.

The present invention is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings, in which like reference numerals indicate identical or functionally similar elements, of which:

FIG. 1 depicts a process for control of polarization in social media, in accordance with some embodiments of the disclosure;

FIG. 2 illustrates an interface on the X platform (formerly Twitter) including an agent for control of polarization in social media, in accordance with some embodiments of the disclosure;

FIG. 3 depicts a flowchart showing how an agent is configured to generate a response to a post from a device associated with a user when it is determined that a post or account associated with another user connected to the user has different views, in accordance with some embodiments of the disclosure;

FIG. 4 depicts a sequence diagram including AI agent response generation using retrieval augmented generation (RAG), in accordance with some embodiments of the disclosure;

FIG. 5 depicts another process for control of polarization including generation of a suggested response to a social media post, in accordance with some embodiments of the disclosure;

FIG. 6 depicts a process for selecting a device associated with a user to present with a suggested response to a social media post, in accordance with some embodiments of the disclosure;

FIG. 7 depicts a process for selecting a response by distance or similarity, in accordance with some embodiments of the disclosure;

FIG. 8 depicts a process for selecting a device associated with a user to present with a suggested response to a social media post based on level of interaction, in accordance with some embodiments of the disclosure;

FIG. 9 depicts a process for training a digital twin model, in accordance with some embodiments of the disclosure;

FIG. 10 depicts a process for selecting another user to present with a suggested response to a social media post, in accordance with some embodiments of the disclosure;

FIG. 11 depicts a process for replacing a manual response with a response to a social media post, in accordance with some embodiments of the disclosure;

FIG. 12 depicts a process for training a model for an AI agent for generating a response to a social media post, in accordance with some embodiments of the disclosure;

FIG. 13 depicts a process for determining an appropriate time for suggesting a response to a social media post, in accordance with some embodiments of the disclosure;

FIG. 14 depicts a process for generating a GUI with options for controlling a response to a social media post, in accordance with some embodiments of the disclosure;

FIG. 15 depicts a process for analyzing audio and video of a social media post for use in generating a response to the social media post, in accordance with some embodiments of the disclosure;

FIG. 16 depicts an AI system for control of polarization in social media, in accordance with some embodiments of the disclosure; and

FIG. 17 depicts a system including a server, a communication network, and a computing device for performing the methods and processes noted herein, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

Methods and systems are provided for use by a platform, such as a social media platform, to achieve numerous advantages including control of polarization on a platform, improved believability, healthy variability of content, versatility through use of one or more AI agents, improved user interaction and engagement, promotion of contextual understanding, engineered prompts, improved content policing, promotion of additional responses, and accommodation of a variety of positions.

In some embodiments, a taxonomy vector is assigned to social media posts, and a position profile is computed for each user. If a shared post's taxonomy vector and a recipient user's position profile differ beyond a threshold, an AI agent generates a response.

Throughout the specification, where the term “taxonomy” is used, it is understood that, in some embodiments, at least one of the following may be provided: typology, categorization, classification, systematic classification, analysis, arrangement, codification, designation, ordering, sorting, benchmarking, comparison, profiling, combinations of the same, or the like.

In some embodiments, the terms “taxonomy” and “taxonomy vector” (or value) are used to describe different aspects of data organization and classification. Taxonomy is the science of naming, describing, and classifying objects based on shared characteristics. Taxonomy is a hierarchical system that organizes data into categories and subcategories based on shared characteristics. In the context of information science, taxonomies are used to create structured frameworks that effectively organize diverse information. This practice involves creating a logical and hierarchical framework for sorting and grouping knowledge based on shared characteristics, themes, or subject matter. The goal is to provide a structured arrangement that facilitates efficient retrieval and understanding of information within a given context.

In some embodiments, the term “taxonomy vector” (or value) refers to a mathematical construct that contains multiple values. For example, the taxonomy vector refers to a representation of an object's classification within a taxonomy, where each element in the vector corresponds to a particular level or category in the taxonomy. For example, consider a simple taxonomy for animals, where the top level is “Animal,” the second level is

“Vertebrate/Invertebrate,” and the third level is “Mammal/Bird/Reptile/Amphibian/Fish.” An elephant, being a vertebrate mammal, could be represented by the taxonomy vector [1, 1, 1], while a trout, being a vertebrate fish, could be represented by the taxonomy vector [1, 1, 5].

In some embodiments, a digital twin of the user is generated to ensure believability and variability in responses. The AI agent can, for example, answer comments, generate nudging comments, police content, sway opinions, and generate additional responses. The system is configurable to assume existence of a variety of positions on the platform.

For the taxonomy description, in some embodiments, the social media platform is configured to use a machine learning model to assign a taxonomy vector to each post, based on its thematic categories and values. For the position profile, in some embodiments, the social media platform also computes a position profile for each user, based on the taxonomy vectors of their posts. For the polarization threshold, in some embodiments, the social media platform is configured to compare the taxonomy vector of a shared post to the position profile of the recipient user and determine if they differ by more than a threshold. For the AI agent, in some embodiments, the social media platform is configured to use an AI agent to generate and suggest a response to the shared post, based on, for example, the opposite or differing position of the original post and the recipient user's position profile.

The responses are not limited to opposite positions. For example, if there is polarization between two groups of users A and B, and a device associated with a user in group A makes a polarizing post, a response to devices associated with users from group B is suggested that is opposite of a position of group A. However, in this example, for users of group A, the polarization score may be decreased by suggesting a response in the same general direction of group A but less extreme. In the example “dogs are far superior to cats!” a moderated response may be, for example, “I like cats better than dogs, but I think they're both great” for opposite users and “I love dogs, but I think both are great” for similar users.

In some embodiments, a system is configured to generate responses to polarizing posts on a platform. When a user's connection makes such a post, the user is notified and offered a suggested response. The suggestion can be edited, posted as is, or discarded in favor of a self-written response. The system considers the interaction level between the two users and may suggest responses to multiple users.

In some embodiments, to ensure believability and variability, the system creates a digital twin of the user by fine-tuning a large language model (LLM) with the user's published content. For example, response generation uses a retrieval augmented generation (RAG) method, where the LLM identifies context and language, and external data points (like the user's posts and contextual information about the original post) are indexed and retrieved to generate the response.

In some embodiments, the AI agent is configured to generate an “engineered prompt” when assigned to a post, which includes the post as context and instructions to generate a response. For example, the response is guided by the RAG process, accessing selected external data points and a knowledge base refined to match the user's position profile. This is important if the original post's subject was not part of the LLM's training set.

In some embodiments, AI agents are configured for answering comments. For example, the media platform may assign an AI agent to answer comments left by other users to a polarizing post, based on the content and position of the comments and the post.

In some embodiments, AI agents are configured for generating nudging comments. For example, the media platform may also use an AI agent to generate a nudging comment to a polarizing post, based on the interaction of the original poster with another user who has allowed the platform to use their profile and content.

In some embodiments, AI agents are configured for policing content. For example, the media platform may use an AI agent to generate a set of candidate responses to a polarizing post and post them under the profiles of the AI agent or another user, to moderate the content without censoring it.

In some embodiments, AI agents are configured for opinion swaying. For example, the media platform may use AI agents to subtly sway the opinion of a user by generating both negative and somewhat positive comments on a polarizing post. The timing and number of AI agents are determined based on the user's posting time and interaction patterns.

In some embodiments, AI agents are configured as digital twins. For example, the media platform may create digital twins of a group of users and generate position statements of these users when a user is about to post polarizing content. The user is informed of these positions before publishing the content.

In some embodiments, AI agents are configured for generating additional responses. For example, the media platform may generate additional responses to a polarizing post when the user starts answering comments posted by the AI agents. The platform may also suggest an answer to a real user when the user provides an answer to a comment suggested by an AI agent.

In some embodiments, a variety of positions or subjects are accommodated on the platform. For example, it is understood a variety of positions exist on the platform and within the user's circle. Examples of subjects of posts that tend to involve differences in terms of bias and accuracy of information include: politics (e.g., left or liberal versus right or conservative); climate change; diets (e.g., vegetarianism versus omnivorous diets); education (e.g., public versus private); medicine (e.g., traditional versus modern, or the efficacy of certain vaccines); print media consumption (e.g., physical books versus e-books); office politics (e.g., work-from-home versus in-office work); energy policy (e.g., renewable energy versus fossil fuels); labor (e.g., AI versus human labor); shopping (e.g., online shopping versus in-store shopping); and sports (e.g., hiring or firing a coach or player after a big loss). Multiple taxonomies may be determined for a given subject. For example, a taxonomy may be determined for at least one of bias in the post, accuracy of the post, engagement of the post, sentiment expressed in the post, influence of the post (e.g., as measured by followers, reach, authority, credibility, relevance, combinations of the same, or the like), popularity of the post (e.g., as measured by views, impressions, clicks, shares, mentions, combinations of the same, or the like), combinations of the same, or the like. These taxonomies may also be analyzed from multiple posts posted by the same user account. In some examples, the taxonomies of multiple posts may be averaged or weighted depending on other listed factors like influence and popularity. In sum, taxonomy is not necessarily simple and may be complex and multifaceted. In some embodiments, specific models are trained for particular types and/or subjects of discussion.

In some embodiments, a first user may post a first piece of content on a social media platform and the social media platform may generate a taxonomy description on the post by using a machine learning model trained for that purpose. Such content may include text, audio segments, videos or images or any combination thereof. The input of the machine learning model may be a word-vectorization of the original post, and the output may be a taxonomy vector where each component of the vector is associated with a score in a thematic category.

In some embodiments, a machine learning model is configured to perform a classification task on social media posts. The input of the model is a word vectorization of the textual information of the social media post. For example, the text is converted into a numerical vector that captures its semantic and syntactic properties. The output of the model is a taxonomy vector. For example, the vector represents the classification of the social media post according to a predefined taxonomy. Each component of the taxonomy vector defines a score in a thematic category. For example, each element of the vector indicates how relevant, important, or similar the social media post is to a certain topic or theme.

The machine learning model may also include a decoding stage such as a computer vision model to analyze an image or a video and/or detect writing in an image using, for example, optical character recognition (OCR). It may also include a speech-to-text transcription for audio portion of the first content. The machine learning model may also be multi-modal and accept all form of media posted on the platform.

In some embodiments, a taxonomy vector may be provided with categories of: [<left politics>,<right politics>,<independent politics>], where each category has a value between 0.00 and 1.00. A textual post may be categorized using the taxonomy vector. For example, the following textual post—“If the United States took 50% of the total inheritance and spread it out evenly among all people turning say 25, that would be $61,000 to each person, which is a far more equitable start at life for everyone, easy to administer, and manifestly fair.”—may be classified per the taxonomy as [0.95,0.00,0.30]. Further, for example, two posts classified using the taxonomy may be compared using, for example, Euclidian distance or cosine similarity. By classifying each post of a user per a defined taxonomy, a social media platform may develop a position profile for each of its users.

In some embodiments, a taxonomy vector for a social media platform may include many (e.g., thousands) of components. A number of components generally depends on a granularity of subject positions and a desired reach for the platform.

Upon detecting that a first content has been shared by a first user connected on the social media platform to a second user, the platform may first compute a taxonomy vector of the first content and compare it to a subset of a position profile of a second user. The subset may be determined for example by eliminating components from the position profile (e.g., using a zeroing or not-a-number (NaN) operation) on the taxonomy vector so that positions of the second user on subjects other than those identified in first content are not influencing the next comparison.

If a difference between the position profile and the taxonomy vector exceeds a threshold, which may be defined by the social media platform or by the second user (e.g., a polarization threshold), then the media platform may query an AI agent trained on the subject of the first content. In some embodiments, the AI agent is trained on the subject of the first content and further fine-tuned with data on, for example, opposite positions of first content to generate a collection of responses to original first content. It then may order these responses by distance to the position profile and select the response having the smallest distance. It may also generate a response directly minimizing the distance to the position profile. That response may then be presented to the second user for approval to be posted as a comment to the first content. In some embodiments, an LLM is configured to generate an answer within certain constraints. For example, the LLM can be prompted to generate an answer in the style of “a right-leaning independent voter.”

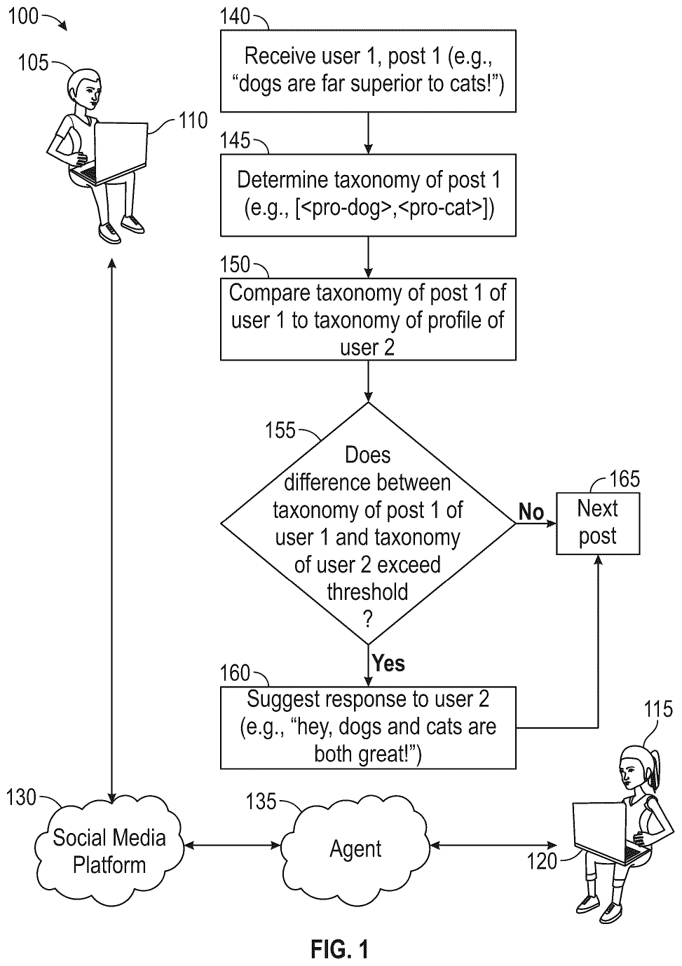

FIG. 1 depicts a process 100 for control of polarization in social media, in accordance with some embodiments of the disclosure. For example, the process 100 involves a first user 105 operating a first user device 110 and a second user 115 operating a second user device 120. The first and second users 105, 115 are engaging with a social media platform 130. An agent 135 is configured to suggest a response to a post by the first user 105 in certain conditions.

In some embodiments, a user selectable prompt or option is provided to edit, approve, or reject a response to the social media post. This feature allows the user to have more control over the quality and content of the responses they receive from an online platform or service. For example, if a first user makes a provocative statement, a second user can choose to edit the suggested response if they want to add or modify some information, approve the response if they are satisfied with it, or reject the response if they find it irrelevant, inaccurate, or inappropriate. The user's feedback helps the platform or service improve its algorithms and learn from the user's preferences. This feature enhances the user's experience and trust in the platform or service and fosters a more constructive and respectful online community.

The process 100 includes receiving 140 from the first user device 110 of the first user 105, a first post (e.g., “Dogs are far superior to cats!”). The process 100 includes determining 145 a taxonomy of the first post (e.g., [<pro-dog>,<pro-cat>]). The process 100 includes comparing 150 the taxonomy of the first post to a taxonomy of a profile of the second user 115. The process 100 includes determining 155 whether a difference between the taxonomy of the first post to the taxonomy of the profile of the second user 115 exceeds a threshold. The process 100 includes, based at least in part on determining 155 the difference between the taxonomy of the first post to the taxonomy of the profile of the second user 115 exceeds the threshold (155=“Yes”), suggesting 160 a response to the second user 115 (e.g., “Hey, dogs and cats are both great!”). The process 100 includes, based at least in part on determining 155 the difference between the taxonomy of the first post to the taxonomy of the profile of the second user 115 does not exceed the threshold (155=“No”), receiving 165 a next post for review by the agent 135. After suggesting 160 the response, the process 100 proceeds to the receiving 165 step.

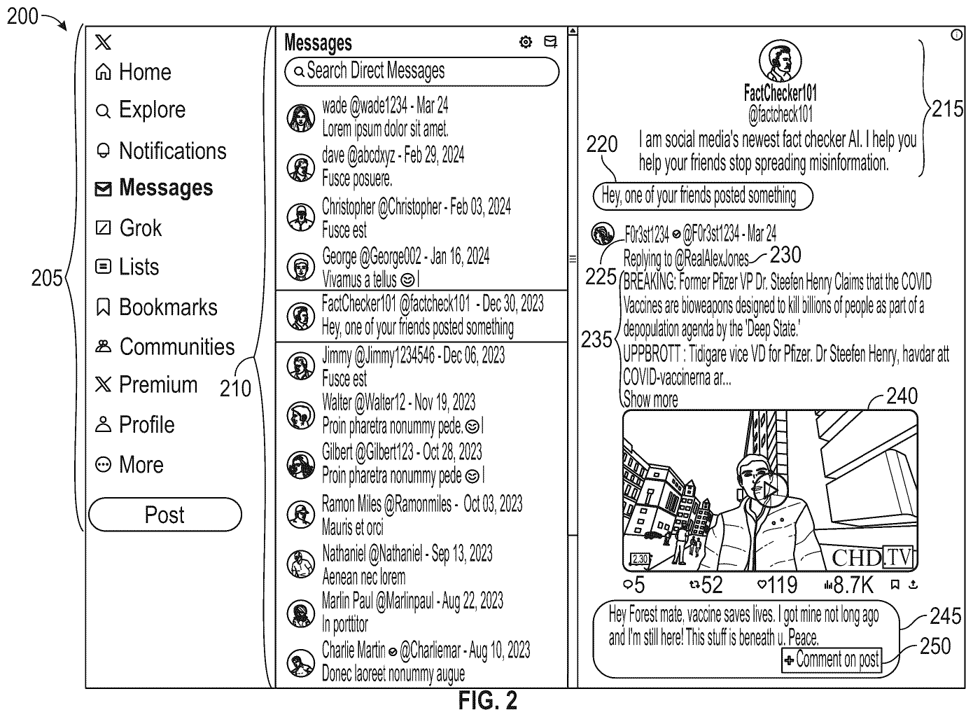

FIG. 2 illustrates an interface 200 on the X platform (formerly Twitter) of a first user, in accordance with some embodiments of the disclosure. The interface 200 includes a conventional navigation section 205 and a conventional message section 210. In some embodiments, an agent 215 (e.g., a hypothetical X account named “FactChecker101” with a user identifier of “@factcheck101”) is configured to analyze a post by a second user, identify polarizing content in the post, and suggest a response to the post having identified polarizing content to the first user. In this example, an account name 225 (e.g., “For3st1234”) of the second user is provided, and the post includes an indicator 230 that the post is a reply to another post (e.g., “Replying to @RealAlexJones”), text 235 from the post (e.g., “BREAKING: Former Pfizer VP . . . ”), and an embedded video 240 (e.g., a video labeled “CHD.TV”). For example, the agent 215 is configured to generate and display a notification 220 (e.g., “Hey, one of your friends posted something”) to the first user. The agent 215 is configured to send a copy of the post triggering the notification to the first user. The agent 215 is configured to generate and display a suggested response 245 (e.g., “Hey Forest mate, vaccine saves lives. I got mine not long ago and I′m still here! This stuff is beneath u. Peace.”) for review and approval by the first user. The agent 215 is configured to display a user selectable option 250 (e.g., a button with a plus sign icon (“+”) displayed next to the text “Comment on post”). Upon selection of the user selectable option 250 by the first user, the suggested response 245 is approved and posted as a response to the post by the second user.

That is, in FIG. 2, the second user receives the notification 220 that a polarizing post was made by one of their connections and are offered the suggested response 245. In addition to offering a second user to post a response, the platform may also offer to edit the response, to not post a response, or to navigate to the first post to enter their own response/comment. In some other examples, the suggestion from the AI agent 215 may be triggered when the second user starts typing a response to the polarizing post.

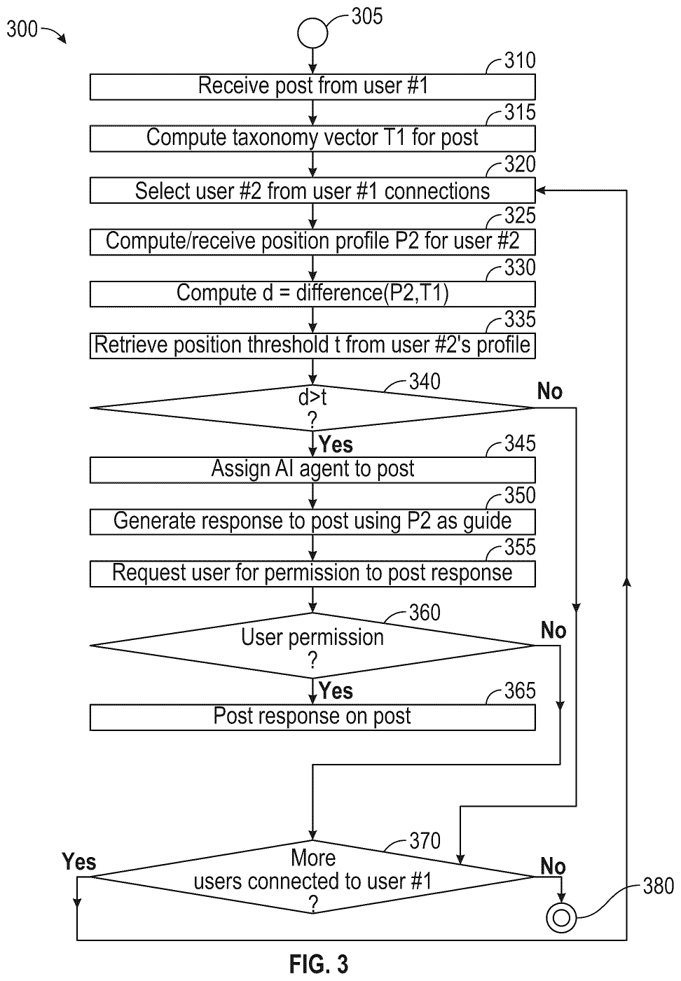

FIG. 3 depicts a flowchart of a process 300 showing how an agent is configured to generate a response to a post from a device associated with a user when it is determined that a post or account associated with another user connected to the user has different views, in accordance with some embodiments of the disclosure. The process 300 includes starting 305 when a post is received 310 from a first user. The process 300 includes computing 315 a taxonomy vector T1 for the post. The process 300 includes selecting 320 a second user from connections of the first user. The process 300 includes computing and receiving 325 a position profile P2 for the second user. The process 300 includes computing 330 a comparison of the position profile P2 and the taxonomy vector T1 for the post (e.g., d=difference (P2,T1)). The process 300 includes retrieving 335 a position threshold t from a profile of the second user. The process 300 includes determining 340 whether the difference d is greater than the position threshold t. The process 300 includes, based at least in part on determining the difference d is greater than the position threshold t (340=“Yes”), assigning 345 an AI agent to the post. The process 300 includes, based at least in part on determining the difference d is not greater than the position threshold t (340=“No”), advancing to step 370 described herein. The process 300 includes generating 350 a response to the post using the position profile P2 as a guide. The process 300 includes requesting 355 permission from the second user to post the response. The process 300 includes determining 360 whether the second user has given permission to post the response. The process 300 includes, based at least in part on determining the second user has given permission to post the response (360=“Yes”), posting 365 the response to the post. The process 300 includes, based at least in part on determining the second user has not given permission to post the response (360=“No”), advancing to step 370 described herein. The process 300 includes determining 370 whether one or more users are connected to the first user. The process 300 includes, based at least in part on determining 370 that one or more users are connected to the first user (370=“Yes”), reverting to the selecting step 320. The process 300 includes, based at least in part on determining 370 that one or more users are not connected to the first user (370=“No”), ending or repeating 380 the process 300 for another post.

The process 300 is not limited to analysis of a text of a post. In some embodiments, in addition to text, information related to the post is analyzed including, for example, a hashtag of the post, a URL provided with the post, content associated with the URL provided with the post, a user identification of another user mentioned in the post, combinations of the same, or the like. In the example of FIG. 2, in addition to analysis of the taxonomy vector T1 for the post and the position profile P2 for the second user, information related to the post is also analyzed. In this example, the second user shared a post by a third user (@RealAlexJones). A taxonomy of the third user is also determined in some embodiments. In some instances, the video 240 may be converted using image-to-text and the extracted text analyzed to determine additional taxonomy information. Comments to the post, a number of reshares of the post, a number of likes of the post, a number of views of the post, combinations of the same, and the like may also contribute to additional taxonomy information.

Before sending a notification or suggestion to a second user, the platform considers the interaction history between the first and second users. The aim is to prioritize users who have previously interacted with the first user, maintaining their usual pattern of interaction.

The platform may choose multiple second users to suggest contrasting responses to the first user's post. It ensures a variety of responses by suggesting posts that reflect each user's past activity.

To create convincing responses, the platform may generate a digital representation of the second user. This is done by fine-tuning an LLM based on the content that the second user has previously published on the platform. This ensures that the responses generated for each second user are varied and personalized.

The method used to create tailored responses to a polarizing post is a variation of the RAG approach. Here, an LLM is used for overall context and language processing. A series of external data points, representing the second user's existing posts and contextual information about the first post's subject, are indexed and retrieved by the AI agent to generate its response.

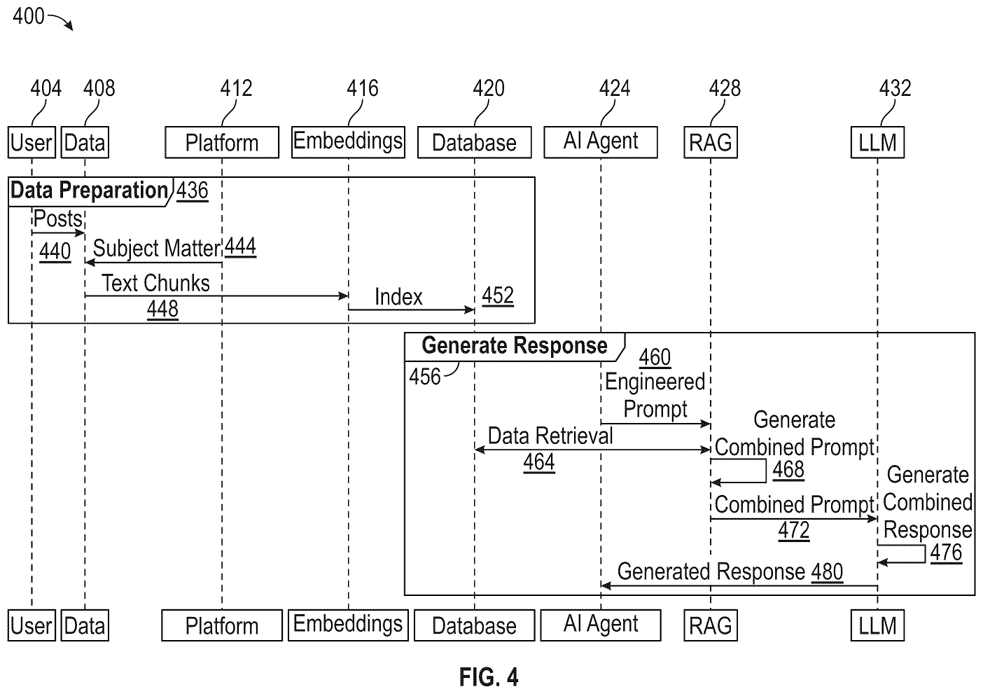

FIG. 4 depicts a sequence diagram 400 including AI agent response generation using RAG, in accordance with some embodiments of the disclosure. The sequence diagram 400 includes interactions between a user 404 (via a user device), a data store 408, a platform 412 (e.g., a social media platform), an embeddings layer 416, a database 420, an AI agent 424, a RAG 428, and an LLM 432. In some embodiments, an integrated AI platform is provided combining the functionalities of, for example, the embeddings layer 416, the AI agent 424, the RAG 428, and the LLM 432. In some embodiments, other generative models like transformer models or variational autoencoders are used for generating responses.

For example, the user 404 is an individual interacting with the system via a user device. The user 404 might be posting to social media. The post may include a question, statement, request, or the like. The data store 408 may include past interactions, user preferences, or other relevant information. The platform 412 may be a social media platform or any other platform where the interaction is taking place. The embeddings layer 416 may be a layer in an AI model that converts input data (like text from the user) into a numerical form that the model can process. The database 420 is a storage of information that the AI model can use to retrieve relevant data during the response generation process. The AI agent 424 may be a trained AI model that is interacting with the user and generating responses. The RAG 428 may be a method used in AI models where the model retrieves relevant information from a database and uses it to generate a response. The LLM 432 may be a type of AI model that processes and generates human-like text.

The sequence diagram 400 includes a data preparation phase 436 and a generate response phase 456. For example, during the data preparation phase 436, the system prepares the data for the AI model. The data preparation could include retrieving relevant data from the database, converting the user's input into a form the model can process using the embeddings layer, and any other necessary preprocessing steps. For example, during the generate response phase 456, the AI model generates a response. For implementations using a RAG method, relevant information is retrieved from the database and used to inform the response it generates.

In some embodiments, the data preparation phase 436 includes storing 440 posts from the user 404 to the data store 408. The data preparation phase 436 includes storing 444 to the data store 408 subject matter determinations made by the platform 412. The data preparation phase 436 includes sending 448 text chunks from the data store 408 to the embeddings layer 416. The embeddings layer 416 may be configured to define a score in a thematic category. The data preparation phase 436 includes storing 452 an index from the embeddings layer 416 to the database 420.

The generate response phase 456 includes sending 460 an engineered prompt generated by the AI agent 424 to the RAG 428. The generate response phase 456 includes exchanging 464 data between the database 420 and the RAG 428. The generate response phase 456 includes generating 468, at the RAG 428, a combined prompt. The generate response phase 456 includes sending 472 the combined prompt from the RAG 428 to the LLM 432. The generate response phase 456 includes generating 476, at the LLM 432, a combined response. The generate response phase 456 includes sending 480 the generated combined response from the LLM 432 to the AI agent 424.

In FIG. 4, the AI agent may generate the engineered prompt upon being assigned to a post. The engineered prompt may include the post in its entirety as context. A multi-modal LLM may be necessary if the post is in a form other than text. The engineered prompt may include instructions such as “generate a response,” and the response generated will be guided by the RAG 428 by accessing selected external data points. The selected external data points include, for example, posts the second user has made (to account for style, use of words, sentence length, and the like) as well as a knowledge base for the first post. The knowledge base may be further refined to only include information that matches the second user's position profile. The knowledge base is important as the first post may be about something that was not included as part of the training set of the LLM 432.

In one embodiment, the media platform might assign an AI agent to respond to comments made by a second user on the first user's polarizing post, based on the content of the second user's comment. For instance, if the second user's comment supports the stance of the polarizing post, the AI agent might generate a counterbalancing response and offer it to a third user whose position profile (P3) is a certain distance (d1) from the original post (T1), and a certain distance (d2) from the second user's comment (T2). Both distances are greater than a predetermined polarization threshold (t). Conversely, if the second user's comment aligns with the direction the platform is nudging the first user towards, the platform might decide not to assign an AI agent to that post or assign an AI agent to generate a supportive response to the second user's comment. For example, using the notation used in the previous example, for implementations where each of the original post and the second user's comment is converted to a representation (e.g., a component of a vector in a multidimensional space) that is measurable by a distance, e.g., the determination is performed with d1=distance (T1,P3)>t and d2=distance (T2,P3)<s, with s being the similar view threshold, fixed by the platform or selected by the third user. Here again P3 is limited to the components that make sense in T1 and T2. For example, if a post is political, a user's position about cats versus dogs is not part of the distance computation between the user's profile and the post.

In another embodiment, a third user might permit the social media platform to generate an AI agent on their behalf. These AI agents could be LLMs fine-tuned on the content generated by the third user. The platform might then choose to include this third user among the second users to generate a nudging comment to the first polarizing post, based on the first user's interaction with the third user. Unlike previous scenarios where a second user is selected based on their connection with the first user, in this case, no such connection may be necessary. The third user could be a celebrity, an influencer the first user follows, or a regular user who has posted content that the first user has interacted with beyond a certain threshold. The AI agent could be fully autonomous, not requiring the third user it is modeled after to interact with it to generate a response to the first polarizing post, or semi-autonomous, submitting generated responses to the third user for approval before posting them.

In yet another embodiment, administrators of the social media platform might want to moderate what is posted on their network without overtly censoring content. The administrators might assign an individual AI agent to generate a set of potential responses. The assigned AI agent might mimic a real person (e.g., be a digital twin of an existing user who has given their permission) or be completely artificial but appear like a normal user to any other user. The platform might then decide to post these responses as comments to the first polarizing content under the profiles of the assigned user agents. In some examples, the platform might also generate a second AI agent capable of generating comments to the first AI agent's own response.

In some embodiments, the social media platform may subtly influence the first user's opinion by controlling the direction of the conversation. This is achieved by generating both negative (from the first AI agent) and somewhat positive (from the second AI agent) responses to the first user's polarizing content. The timing of the first AI agent's response and the number of AI agents assigned to the content are calculated based on the user's posting time and the interaction patterns with the user's previous posts. For instance, if a user's post has received responses from n real users and p AI agents, only n real users are considered when assigning AI agents to the user's next post. The platform keeps track of responses from real users and AI agents separately.

In another embodiment, the platform creates digital twins of a group of second users. These digital twins can generate position statements when the platform detects that the first user is about to post first polarizing content. Before publishing the first polarizing content, the platform may inform the first user of the positions of a group of second users that are connections of the first user. For example, the positions are generated by AI agents of the group of second users. The platform may then ask for confirmation to publish the first polarizing content.

In other embodiments, the platform may generate additional responses to the polarizing content when the first user starts responding to comments posted by the AI agents. These new responses are guided by adding the first user's response to the context of the first generated response. The platform may suggest a response to a real second user when the first user replies to a comment suggested by an AI agent and posted by the second user. The platform may stop generating responses when the first user's position aligns with the platform's target position.

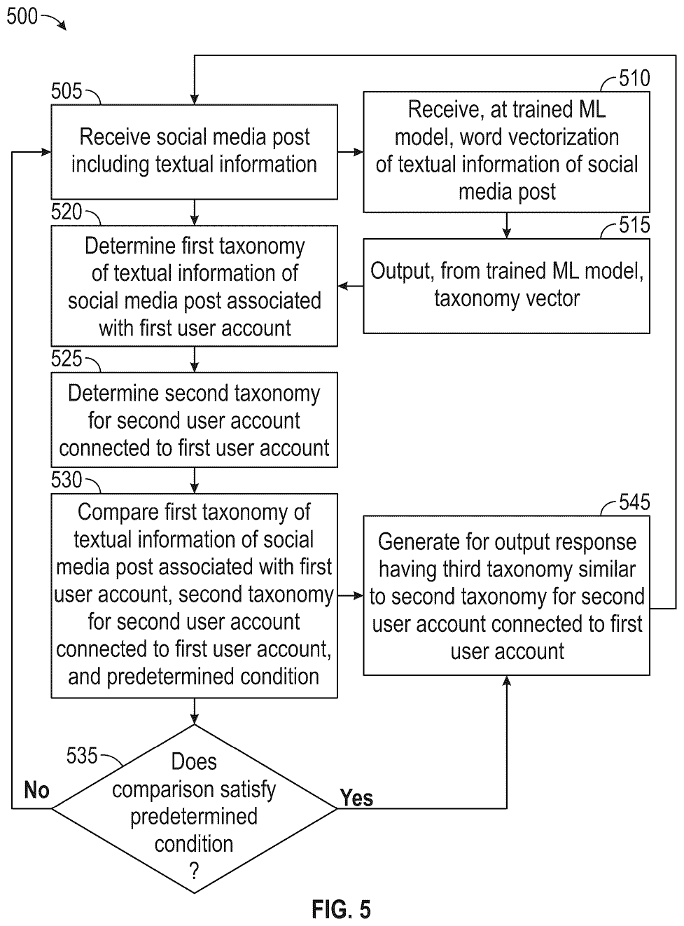

FIG. 5 depicts a process 500 for control of polarization including generation of a suggested response to a social media post, in accordance with some embodiments of the disclosure. The process 500 involves, for example, receiving a social media post and determining taxonomies for the post and a connected user account. The taxonomies are compared against a predetermined condition. For example, the post has a taxonomy with a score of 0.10 on a scale of 0.00 to 1.00, the scale representing polarization with respect to a given topic, the connected user account has a taxonomy with a score of 0.55, and a predetermined condition of the connected user account is a taxonomy between 0.25 and 0.75. In this example, the connected user account with the 0.55 score satisfies the predetermined condition; whereas, a connected user account having a score similar to that of the post (e.g., 0.20) or extreme on an opposite end of the scale (e.g., 0.90), such accounts would be precluded by the predetermined condition. The predetermined condition is not intended to be limiting and includes any suitable method for comparing a measured taxonomy to a desired or target taxonomy.

If the comparison satisfies the condition, a response is generated with a taxonomy of the response within a certain range of the taxonomy of the original post or within a range of a desired target taxonomy (e.g., 0.25 to 0.75 in the earlier example). The taxonomies can be scored in any suitable manner, e.g., on a linear scale. A machine learning model may be used to determine the taxonomies, which are represented as vectors. The comparison can be based, for example, on the Euclidean distance exceeding a certain threshold, or based on cosine similarity being less than a certain threshold. The process 500 can be repeated for subsequent posts. For example, the process 500 includes receiving 505 a social media post including at least textual information, wherein the social media post is associated with a first user account. The social media post is not limited to textual information. In some embodiments, the social media post includes non-textual information, such as an image, a video, audio, combinations of the same, and the like.

In some embodiments, the process 500 includes determining, using, for example, natural language processing or machine learning, whether the social media post conveys one or more of at least a message, an opinion, an allegation, a fact, a rumor, a suggestion, a question, a command, a compliment, a complaint, a joke, a story, a report, combinations of the same, or the like.

For example, a model is trained to provide the third taxonomy that is relevant and appropriate to the second user's content with a goal of fostering engagement or providing information that aligns with desired interests or viewpoints. The third taxonomy may be tested and evaluated with feedback from humans or other models trained to link content expressions to particular interests or viewpoints. Such models may be further trained to strike a balance between polemic or extreme positions and normalized with well-established facts and known reliable sources of information. For example, the models are trained to understand and categorize content in a way that aligns with human understanding and interests. The third taxonomy, in this context, refers to a classification system that is generated by a model to be relevant and appropriate to desired content (e.g., less polarized and/or more neural content), with an aim of enhancing engagement or providing information that resonates with broader interests or viewpoints. In some implementations, both human feedback and computational evaluation are provided. Human feedback may come from domain experts who assess the taxonomy's relevance and appropriateness, or from users who interact with the system and provide implicit or explicit signals about the utility of the generated taxonomy. Other models, possibly trained on different datasets or designed for related tasks, can also provide a form of computer-generated peer review by evaluating the coherence and relevance of the taxonomy's classifications. Moreover, these models can be refined through iterative training processes that incorporate feedback loops. This allows the models to learn from their successes and mistakes, gradually improving their ability to generate taxonomies that strike a balance between diverse viewpoints and well-established facts. By leveraging LLMs, which can generate rich and relevant concepts, descriptions, and examples for various intents (again, e.g., less polarized and/or more neural content), the taxonomy can be made more dynamic and adaptable to the fluid nature of human interests and discourse. Furthermore, the models can be trained to normalize extreme positions by referencing reliable sources of information and established facts. This involves training the models on datasets that include fact-checked information and authoritative content, which can guide the model towards generating taxonomies that are grounded in reality and provide a balanced perspective.

The process 500 includes determining 520 a first taxonomy of the textual information of the social media post associated with the first user account. The process 500 includes determining 525 a second taxonomy for a second user account connected to the first user account. The process 500 includes comparing 530 the first taxonomy of the textual information of the social media post associated with the first user account, the second taxonomy for the second user account connected to the first user account, and a predetermined condition. The process 500 includes generating 545 for output a response having a third taxonomy similar to the second taxonomy for the second user account connected to the first user account.

In some embodiments, similarity between two taxonomies is performed with any suitable method for determining similarity including at least one of edge-counting, feature-based, attribute-based, information content-based, distributional, statistical, combinations of the same, or the like. For example, for a vector-based taxonomy, similarity may be determined using a Jaccard index or cosine similarity. Other similarity methods include scoring systems along a linear scale, e.g., determining, for each post or account, a score for bias and a score for reliability, and comparing such scores with each other and/or to a standard representing low or no bias and relatively high reliability.

In some embodiments, the process 500 includes determining 535 whether the comparison satisfies the predetermined condition. The process 500 includes, based at least in part on the comparison of the first taxonomy of the textual information of the social media post associated with the first user account and the second taxonomy for the second user account connected to the first user account satisfying the predetermined condition (535=“Yes”), generating 545 for output a response having a third taxonomy similar to the second taxonomy for the second user account connected to the first user account. In some embodiments, the process 500 reverts to the receiving step 505 for a next social media post.

In some embodiments, each of the first taxonomy, the second taxonomy, and the third taxonomy is scored in any suitable manner. For example, for implementations where the taxonomy includes a vector, scoring is performed along a linear scale. As noted, for example, in the example above, a taxonomy vector may be provided with categories of: [<left politics>,<right politics>,<independent politics>], where each category has a value between 0.00 and 1.00. In this example, each component of the vector is scored along a linear scale from 0.00 to 1.00.

In some embodiments, the determining 520 the first taxonomy of the textual information of the social media post associated with the first user account includes utilizing a trained machine learning model trained to determine taxonomies of posts. In some embodiments, the trained machine learning model is configured to receive 510 a word vectorization of the textual information of the social media post and output 515 a taxonomy vector. For example, each component of the taxonomy vector is associated with a score in a thematic category.

In some embodiments, the comparing 530 of the first taxonomy of the textual information of the social media post associated with the first user account and the second taxonomy for the second user account connected to the first user account satisfying the predetermined condition is based at least in part on a Euclidian distance between a first taxonomy vector of the first taxonomy and a second taxonomy vector of the second taxonomy exceeding a predetermined polarization threshold.

In some embodiments, the comparing 530 of the first taxonomy of the textual information of the social media post associated with the first user account and the second taxonomy for the second user account connected to the first user account satisfying the predetermined condition is based at least in part on a cosine similarity between a first taxonomy vector of the first taxonomy and a second taxonomy vector of the second taxonomy being less than a predetermined polarization threshold.

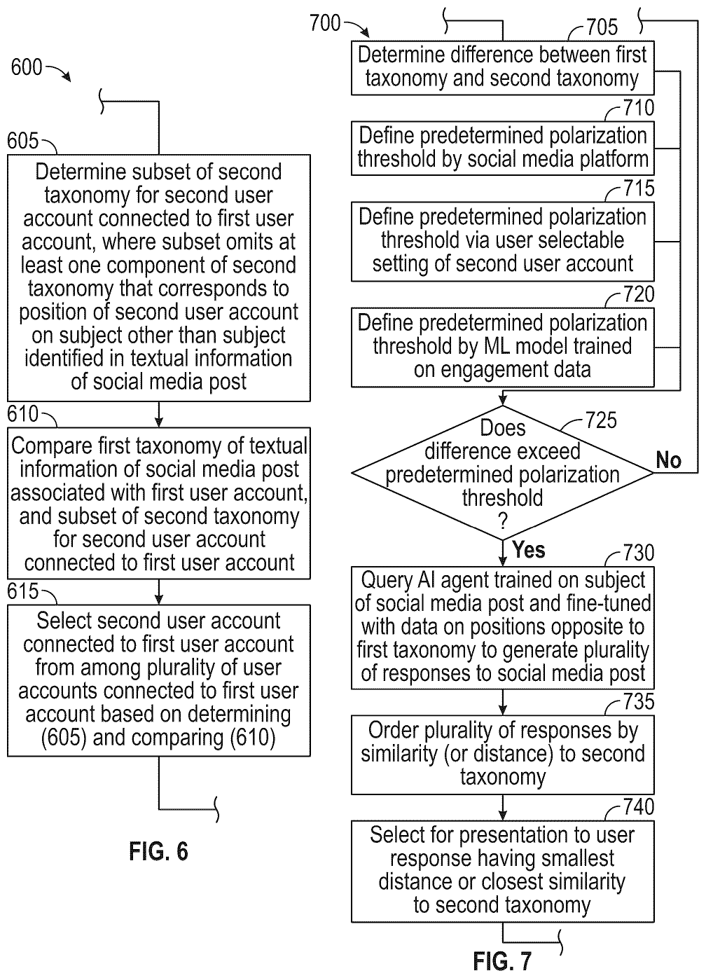

FIG. 6 depicts a process 600 for selecting a device associated with a user to present with a suggested response to a social media post, in accordance with some embodiments of the disclosure. The process 600 involves, for example, determining a subset of the second taxonomy for a connected user account by eliminating components not related to the subjects identified in the post. This subset and the first taxonomy of the post are then compared. Based on this comparison, a device associated with a user is selected from among multiple connected users to present with a suggested response. The positions of the second user on subjects not identified in the post do not influence the comparison. The process 600 can revert to another step, such as determining the second taxonomy.

For example, the process 600 includes determining 605 a subset of the second taxonomy for the second user account connected to the first user account. In some embodiments, the subset omits at least one component of the second taxonomy. As such, positions of the second user account on subjects other than subjects identified in the textual information of the social media post do not influence the comparison. The process 600 includes comparing 610 the first taxonomy of the textual information of the social media post associated with the first user account, and the subset of the second taxonomy for the second user account connected to the first user account. In some embodiments, the positions of the second user account on subjects other than the subjects identified in the textual information of the social media post do not influence the comparison. The process 600 includes selecting 615 the second user account connected to the first user account from among a plurality of second user accounts connected to the first user account based on the determining 605 and the comparing 610. In some embodiments, the process 600 reverts to another step, such as the determining step 525.

FIG. 7 depicts a process 700 for selecting a response by distance or similarity, in accordance with some embodiments of the disclosure. For example, the process 700 includes, for the comparing 530 of the first taxonomy of the textual information of the social media post associated with the first user account and the second taxonomy for the second user account connected to the first user account satisfying the predetermined condition, determining 705 a difference between the first taxonomy and the second taxonomy. In some embodiments, a predetermined polarization threshold is defined 710 by a social media platform providing the social media post. In some embodiments, a predetermined polarization threshold is defined 715 by a user selectable setting of the second user account. In some embodiments, a predetermined polarization threshold is defined 720 by a machine learning model trained on engagement data from one or more social media posts having content associated with the first taxonomy or the second taxonomy.

In some embodiments, the process 700 includes determining 725 whether the difference between the first taxonomy and the second taxonomy exceeds the predetermined polarization threshold. For example, the process 700 is for selecting a response based on similarity or distance. The process 700 compares the taxonomies of two user accounts' social media posts, determines the difference, and checks if it exceeds a predetermined polarization threshold. If it does, an AI agent generates responses, orders them by similarity to the second taxonomy, and selects the closest one. If the difference does not exceed the threshold, the process 700 reverts to another step.

For example, the process 700 includes, based at least in part on determining the

difference exceeds the predetermined polarization threshold (725=“Yes”), querying 730 an AI agent trained on a subject of the social media post and fine-tuned with data on positions differing from (e.g., opposing or opposite to) the first taxonomy to generate a plurality of responses to the social media post.

The process 700 includes ordering 735 the plurality of the responses by a distance or similarity to the second taxonomy. The process 700 includes selecting 740 for presentation to the user the response having a smallest distance or a closest similarity to the second taxonomy. The process 700 includes, based at least in part on determining the difference does not exceed the predetermined polarization threshold (725=“No”), reverting to another step, such as the receiving step 505 for a next social media post.

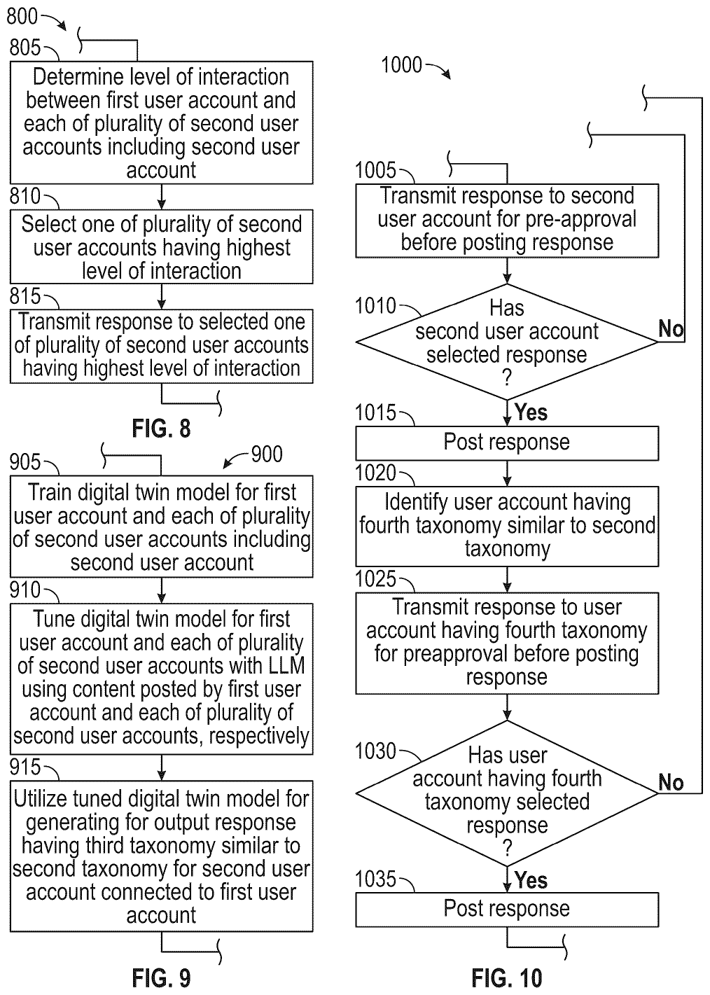

FIG. 8 depicts a process 800 for selecting a device associated with a user to present with a suggested response to a social media post based on level of interaction, in accordance with some embodiments of the disclosure. For example, the process 800 includes determining 805 a level of interaction between the first user account and each of a plurality of second user accounts including the second user account. The process 800 includes selecting 810, as the second user account, one of the plurality of second user accounts having a highest level of interaction. That is, those second user accounts in regular communication with the first user account may be favored in some embodiments. The process 800 includes transmitting 815 the response to the selected one of the plurality of second user accounts having the highest level of interaction. In some embodiments, the process 800 reverts to another step, such as the receiving step 505 for a next social media post.

FIG. 9 depicts a process 900 for training a digital twin model, in accordance with some embodiments of the disclosure. The training of the digital twin model includes at least one of data collection, data preprocessing, model selection, model training, evaluation, hyperparameter tuning, deployment, combinations of the same, or the like. For example, the process 900 includes training 905 a digital twin model for the first user account and each of a plurality of second user accounts including the second user account. The process 900 includes tuning 910 the digital twin model for the first user account and each of the plurality of second user accounts with a large language model using content posted by the first user account and each of the plurality of second user accounts, respectively. The process 900 includes utilizing 915 the tuned digital twin model for the generating for output the response having the third taxonomy similar to the second taxonomy for the second user account connected to the first user account. In some embodiments, the process 900 is part of the generating step 545.

FIG. 10 depicts a process 1000 for selecting another user to present with a suggested response to a social media post, in accordance with some embodiments of the disclosure. For example, the process 1000 includes transmitting 1005 the response to the second user account for pre-approval before posting the response. The process 1000 includes determining 1010 whether the second user account selected the response. The process 1000 includes, based at least in part on user selection of the response by the second user account (1010=“Yes”), posting 1015 the response. The process 1000 includes, based at least in part on no user selection of the response by the second user account (1010=“No”), reverting to another step, such as the receiving step 505 for a next social media post.

In some embodiments, the process 1000 includes, based at least in part on the second user account posting 1015 the response, identifying 1020 a user account having a fourth taxonomy similar to the second taxonomy. The process 1000 includes transmitting 1025 the response (or a variant thereof) to the user account having the fourth taxonomy for pre-approval before posting the response. The process 1000 includes determining 1030 whether the user account having the fourth taxonomy has selected the response. The process 1000 includes, based at least in part on user selection of the response by the user account having the fourth taxonomy (1030=“Yes”), posting 1035 the response. The process 1000 includes, based at least in part on no user selection of the response by the user account having the fourth taxonomy (1030=“No”), reverting to another step, such as the receiving step 505 for a next social media post.

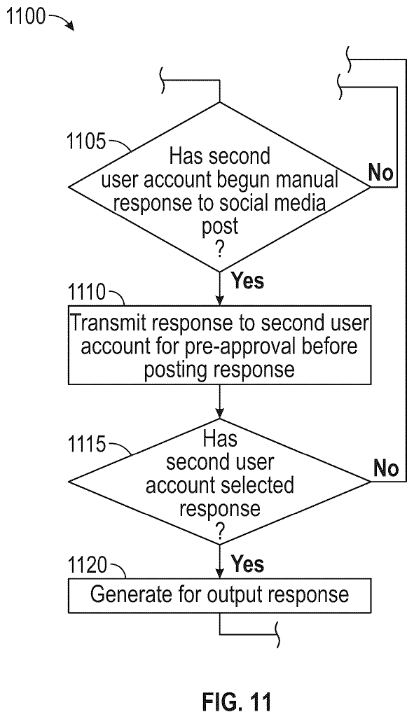

FIG. 11 depicts a process 1100 for replacing a manual response with a response to a social media post, in accordance with some embodiments of the disclosure. For example, the process 1100 includes determining 1105 whether the second user account has begun a manual response to the social media post. The process 1100 includes, based at least in part on the second user account beginning a manual response to the social media post (1105=“Yes”), transmitting 1110 the response to the second user account for pre-approval before posting the manual response. The process 1100 includes, based at least in part on the second user account not beginning a manual response to the social media post (1105=“No”), reverting to another step, such as not posting the AI generated response, but posting instead a user generated post. The another step may be the receiving step 505 for a next social media post.

In some embodiments, the process 1100 includes, determining 1115 whether a user selection of the response was made by the second user account. The process 1100 includes, based at least in part on user selection of the response by the second user account (1115=“Yes”), generating 1120 for output the response. The process 1100 includes, based at least in part on no user selection of the response by the second user account (1115=“No”), reverting to another step, such as the receiving step 505 for a next social media post. Also, the process 1100 includes, based at least in part on the generating 1120 for output the response, reverting to another step, such as the receiving step 505 for a next social media post.

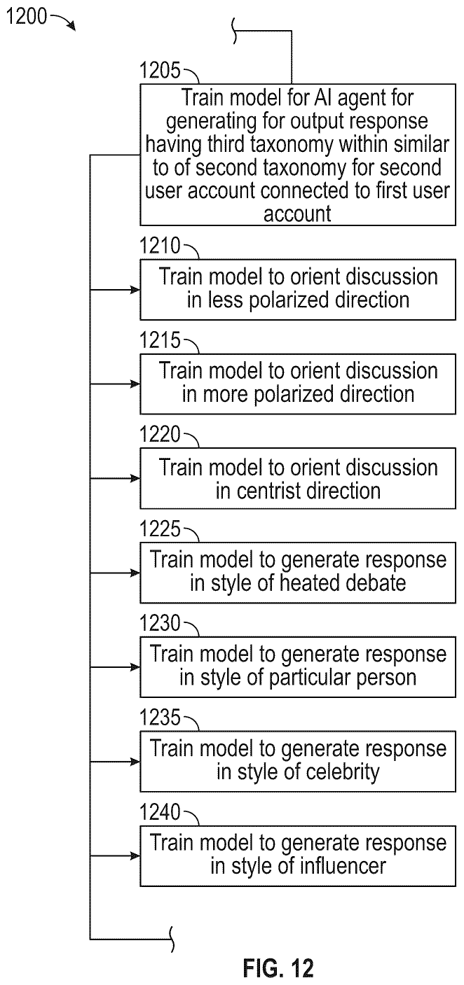

FIG. 12 depicts a process 1200 for instructing a model for an AI agent for generating a response to a social media post, in accordance with some embodiments of the disclosure. The instructing of the model for the AI agent includes at least one of data collection, data preprocessing, model selection, model training, evaluation, hyperparameter tuning, deployment, combinations of the same, or the like. For example, the process 1200 includes training 1205 a model for an automated AI agent for generating for output the response having the third taxonomy similar to the second taxonomy for the second user account connected to the first user account. The process 1200 includes training the model. In some embodiments, the training of the model may include at least one of the steps that follow. For example, the process 1200 includes training 1210 the model to orient a discussion including the social media post in a less polarized direction. The process 1200 includes training 1215 the model to orient a discussion including the social media post in a more polarized direction. The process 1200 includes training 1220 the model to orient a discussion including the social media post in a centrist direction. The process 1200 includes training 1225 the model to generate the response in a style of a heated debate. The process 1200 includes training 1230 the model to generate the response in a style of a particular person. The process 1200 includes training 1235 the model to generate the response in a style of a celebrity. The process 1200 includes training 1240 the model to generate the response in a style of an influencer. In some embodiments, the process 1200 is part of the generating step 545.

For example, the LLM is trained in a plurality of styles. The AI agent instructs the LLM to generate a response in a certain style. Prompt engineering may be provided in addition to or in lieu of steps 1210-1225. For steps 1230-1240, in some embodiments, fine tuning of the model or use of RAG to generate a new style is not necessarily required. In some embodiments, for example when a targeted person (e.g., a celebrity or an influencer) is part of the original training of the LLM, fine tuning and/or RAG may be provided.

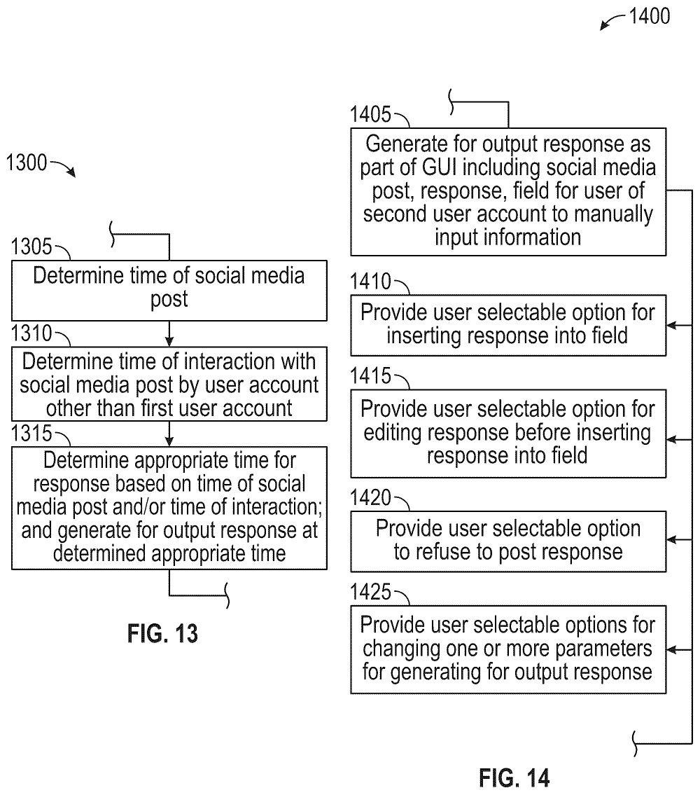

FIG. 13 depicts a process 1300 for determining an appropriate time for suggesting a response to a social media post, in accordance with some embodiments of the disclosure. For example, the process 1300 includes determining 1305 a time of the social media post. For example, a timestamp provides context about when users are most likely to see and interact with the post. Also, for example, the process 1300 includes computing an appropriate time to generate a first AI agent response to first polarizing content by taking into account a time of a post of a first user and one or more interaction patterns of one or more other users with the post of the first user. The process 1300 includes determining 1310 a time of an interaction with the social media post by the user account other than the first user account. For example, the interaction includes commenting, liking, or sharing the post. These interactions provide insights into when the post is receiving the most attention. The process 1300 includes determining 1315 an appropriate time for the response based on the time of the social media post and the time of the interaction with the social media post by the user account other than the first user account and generating for output the response at the determined appropriate time. One goal is to ensure that the response is timely and reaches a maximum number of users. In some embodiments, the process 1300 is part of the generating step 545. The process 1300 allows for more effective and timely AI interactions on social media platforms, ensuring that the responses are seen and engaged with by a larger audience.

FIG. 14 depicts a process 1400 for generating a GUI with options for controlling a response to a social media post, in accordance with some embodiments of the disclosure. For example, the process 1400 includes generating 1405 for output the response as part of a GUI including the social media post, the response, and a field for a device associated with a user of the second user account to manually input information. The GUI may be, for example, that shown in FIG. 2. The process 1400 includes providing 1410 the GUI with a user selectable option for inserting the response into the field (such as the user selectable option 250). The process 1400 includes providing 1415 the GUI with a user selectable option for editing the response before inserting the response into the field. The process 1400 includes providing 1420 the GUI with a user selectable option for refusing to post the response. The process 1400 includes providing 1425 the GUI with user selectable options for changing one or more parameters for generating for output the response. In some embodiments, the process 1400 is part of the generating step 545.

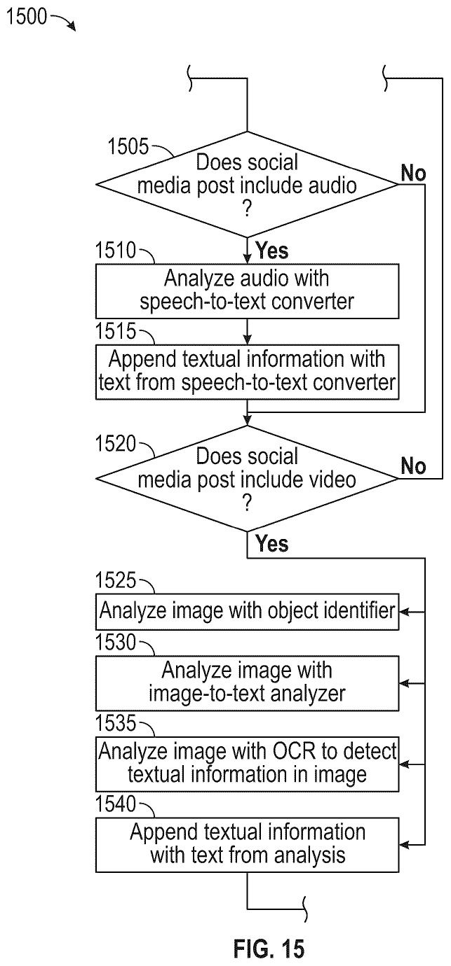

FIG. 15 depicts a process 1500 for analyzing audio and video of a social media post for use in generating a response to the social media post, in accordance with some embodiments of the disclosure. For example, the process 1500 includes determining 1505 whether the social media post includes audio. The process 1500 includes, based at least in part on determining the social media post includes audio (1505=“Yes”), analyzing 1510 the audio with a speech-to-text converter. The process 1500 includes appending 1515 the textual information with text from the speech-to-text converter. The process 1500 includes, based at least in part on determining the social media post does not include audio (1505=“No”), determining 1520 whether the social media post includes, for example, video, a photo, or some other form of visual media. In some embodiments, the determining step 1505 and the determining step 1520 are reversed. In some embodiments, one of the determining step 1505 and the determining step 1520 is omitted.

The process 1500 includes, based at least in part on determining the social media post includes an image (1520=“Yes”), analyzing 1525 the image with an object identifier. The process 1500 includes appending 1540 the textual information with text from the object identifier. The process 1500 includes, based at least in part on determining the social media post includes an image (1520=“Yes”), analyzing 1530 the image with an image-to-text analyzer. The process 1500 includes appending 1540 the textual information with text from the image-to-text analyzer. The process 1500 includes, based at least in part on determining the social media post includes an image (1520=“Yes”), analyzing 1535 the image with OCR to detect textual information in the image. The process 1500 includes appending 1540 the textual information with text from the OCR. In some embodiments, the process 1500 is part of the generating step 545. The process 1500 includes, based at least in part on determining the social media post does not include an image (1520=“No”), reverting to another step, such as the receiving step 505 for a next social media post.

In addition to social media posts on social media networks, the present systems and methods are applicable to all manner of platforms where multiple users interact including online communications platforms where user-generated content, digital media, and digital content are shared.

Throughout the present disclosure, in some embodiments, determinations, predictions, likelihoods, and the like are determined with one or more predictive models. In some embodiments, the model receives various forms of data about users, media content items, devices, and more. This includes usage data, load-balancing data, and metadata. The model performs analysis based on hard rules, learning rules, hard models, learning models, usage data, load data, analytics, metadata, profile information, or combinations of these. The model outputs predictions of a future state of any of the devices described. Load-increasing events are determined by load-balancing processes. The model is based on inputs including hard rules, user-defined rules, rules defined by content providers, hard models, learning models, or combinations of these. The model is trained with data using various data processes, analytical processes, and machine learning approaches. It includes regression and classification analyses. An example of a multi-layer neural network is provided. The model is based on data engineering and modeling processes, and is operationalized using registration, deployment, monitoring, and retraining processes. The model is configured to output results to one or multiple devices, which can perform various functions. The devices can be a server, tablet, media display device, network-connected computer, media device, computing device, or combinations of these. The model outputs a current state, future state, determination, prediction, or likelihood. These outputs may be compared to a predetermined or determined standard. If the standard is satisfied or rejected, the predictive process outputs at least one of the current state, future state, determination, prediction, or likelihood to any device or module disclosed.

In some embodiments, the model ingests diverse forms of data about users, digital content items, devices, and more. This encompasses user interaction data, load-distribution data, and metadata. The model conducts analysis based on deterministic rules, learned rules, deterministic models, learned models, user interaction data, load data, analytics, metadata, user profile information, or combinations thereof. The model generates predictions of a future state of any of the described devices. Load-increasing events are identified by load-distribution processes.

The model is constructed based on inputs including deterministic rules, user-defined rules, rules defined by content providers, deterministic models, learned models, or combinations thereof. The model is trained with data using various data processing methods, analytical processes, and machine learning techniques. It includes regression and classification analyses. An example of a deep neural network is provided.

The model is built upon data engineering and modeling processes and is operationalized using registration, deployment, monitoring, and retraining processes. The model is designed to output results to one or multiple devices, which can perform various functions. The devices can be a server, tablet, digital display device, network-connected computer, media device, computing device, or combinations thereof.

The model outputs a current state, future state, determination, prediction, or probability. These outputs may be compared to a predetermined or determined benchmark. If the benchmark is met or not met, the predictive process outputs at least one of the current state, future state, determination, prediction, or probability to any device or module disclosed.

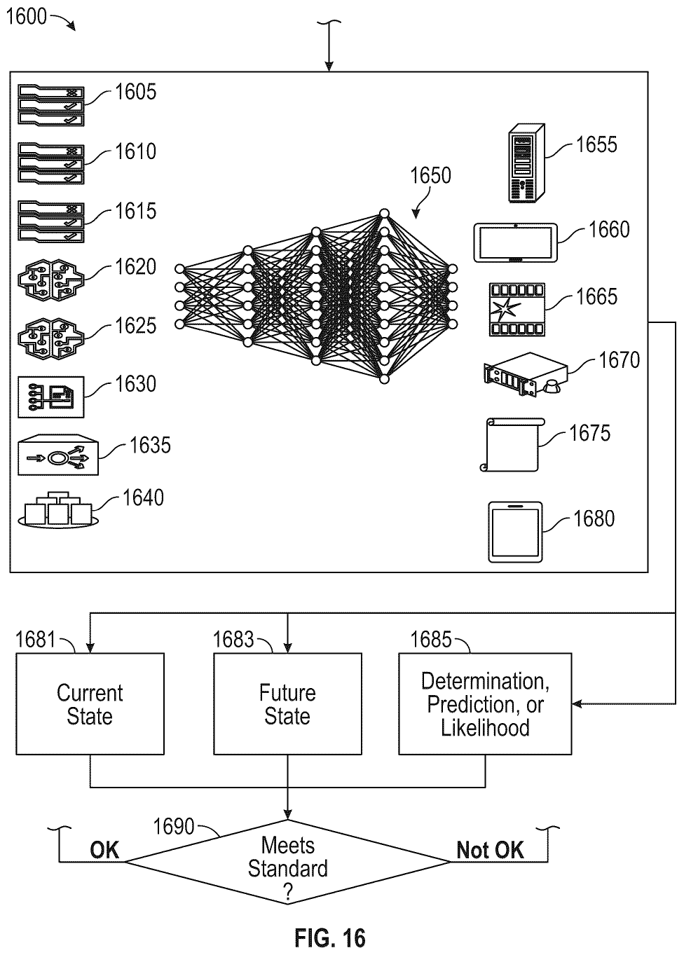

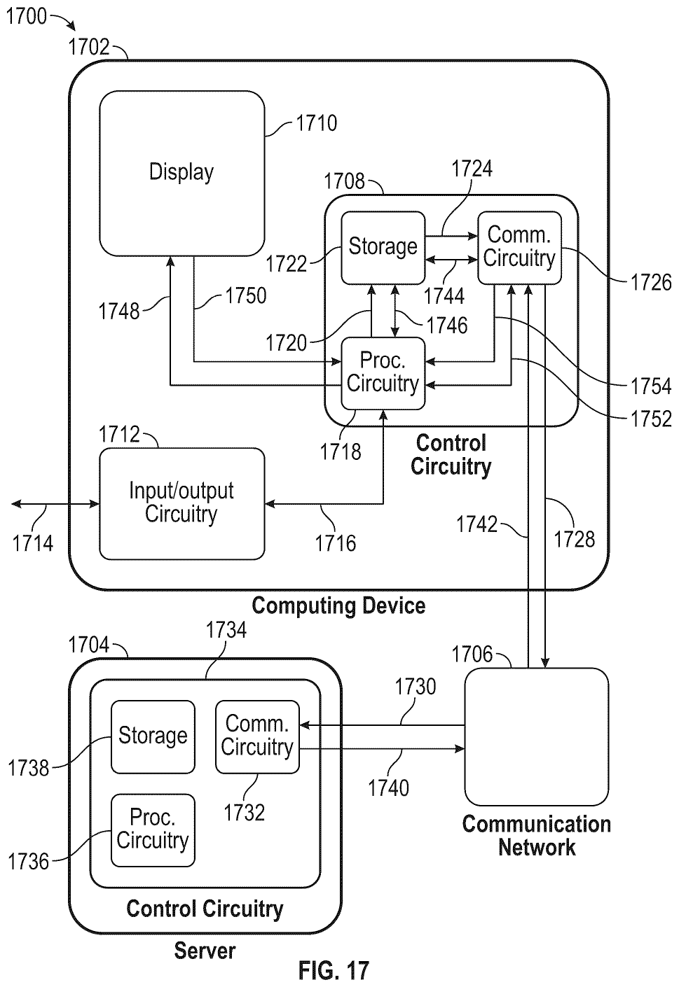

For example, FIG. 16 depicts a predictive model. A prediction process 1600 includes a predictive model 1650 in some embodiments. The predictive model 1650 receives as input various forms of data about one, more or all the users, media content items, devices, and data described in the present disclosure. The predictive model 1650 performs analysis based on at least one of hard rules, learning rules, hard models, learning models, usage data, load data, analytics of the same, metadata, profile information, combinations of the same, or the like. The predictive model 1650 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 1650 is based on input including at least one of a hard rule 1605, a user-defined rule 1610, a rule defined by a content provider 1615, a hard model 1620, a learning model 1625, combinations of the same, or the like.

The predictive model 1650 receives as input usage data 1630. The predictive model 1650 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 1650 receives as input load-balancing data 1635. The predictive model 1650 is based on at least one of load data of the display device, load data of the requesting media device, load data of the media content item, load data of the communication system or network, load data of the profile, load data of the media device, combinations of the same, or the like.

The predictive model 1650 receives as input metadata 1640. The predictive model 1650 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 1650 is trained with data. The training data is developed in some embodiments using one or more data processes including but not limited to data selection, data sourcing, and data synthesis. The predictive model 1650 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 1650 is trained in some embodiments with one or more machine learning approaches including but not limited to supervised learning, unsupervised learning, semi-supervised learning, reinforcement learning, and dimensionality reduction. The predictive model 1650 in some embodiments includes regression analysis including analysis of variance (ANOVA), linear regression, logistic regression, ridge regression, and/or time series. The predictive model 1650 in some embodiments includes classification analysis including decision trees and/or neural networks. In FIG. 16, a depiction of a multi-layer neural network is provided as a non-limiting example of a predictive model 1650, the neural network including an input layer (left side), three hidden layers (middle), and an output layer (right side) with 32 neurons and 192 edges, which is intended to be illustrative, not limiting. The predictive model 1650 is based on data engineering and/or modeling processes. The data engineering processes include exploration, cleaning, normalizing, feature engineering, and scaling. The modeling processes include model selection, training, evaluation, and tuning. The predictive model 1650 is operationalized using registration, deployment, monitoring, and/or retraining processes.

The predictive model 1640 is configured to output results to a device or multiple devices. The device includes means for performing one, more, or all the features referenced herein of the systems, methods, processes, and outputs of one or more of FIGS. 1-15, in any suitable combination. The device is at least one of a server 1655, a tablet 1660, a media display device 1665, a network-connected computer 1670, a media device 1675, a computing device 1680, combinations of the same, or the like.

The predictive model 1650 is configured to output a current state 1681, and/or a future state 1683, and/or a determination, a prediction, or a likelihood 1685, and the like. The current state 1681, and/or the future state 1683, and/or the determination, the prediction, or the likelihood 1685, and the like may be compared 1690 to a predetermined or determined standard. In some embodiments, the standard is satisfied (1690 =OK) or rejected (1690 =NOT OK). If the standard is satisfied or rejected, the predictive process 1600 outputs at least one of the current state, the future state, the determination, the prediction, the likelihood to any device or module disclosed herein, combinations of the same, or the like. In some embodiments, the predictive model 1650 incorporates one or more LLMs.

A communication system is provided including a computing device, a server, and a communication network. Both the server and the communication network can exist in multiple forms and can connect directly or indirectly. The computing device includes control circuitry, a display, and I/O circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit them to the remote server for processing. Both the server and the computing device can transmit and receive content via the communication network or directly, and the processing circuitry receives the user input and converts it to digital signals.

In some embodiments, the system is a distributed network architecture with an edge device (a type of computing device 1702), a cloud server (a type of server 1704), and an internet of things (IOT) network (a type of communication network 1706). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

FIG. 17 depicts a block diagram of system 1700, in accordance with some embodiments. The system is shown to include computing device 1702, server 1704, and a communication network 1706. It is understood that while a single instance of a component may be shown and described relative to FIG. 17, additional embodiments of the component may be employed. For example, server 1704 may include, or may be incorporated in, more than one server. Similarly, communication network 1706 may include, or may be incorporated in, more than one communication network. Server 1704 is shown communicatively coupled to computing device 1702 through communication network 1706. While not shown in FIG. 17, server 1704 may be directly communicatively coupled to computing device 1702, for example, in a system absent or bypassing communication network 1706.

Communication network 1706 may include one or more network systems, such as, without limitation, the Internet, LAN, Wi-Fi, wireless, or other network systems suitable for audio processing applications. The system 1700 of FIG. 17 excludes server 1704, and functionality that would otherwise be implemented by server 1704 is instead implemented by other components of the system depicted by FIG. 17, such as one or more components of communication network 1706. In still other embodiments, server 1704 works in conjunction with one or more components of communication network 1706 to implement certain functionality described herein in a distributed or cooperative manner. Similarly, the system depicted by FIG. 17 excludes computing device 1702, and functionality that would otherwise be implemented by computing device 1702 is instead implemented by other components of the system depicted by FIG. 17, such as one or more components of communication network 1706 or server 1704 or a combination of the same. In other embodiments, computing device 1702 works in conjunction with one or more components of communication network 1706 or server 1704 to implement certain functionality described herein in a distributed or cooperative manner.

Computing device 1702 includes control circuitry 1708, display 1710 and input/output (I/O) circuitry 1712. Control circuitry 1708 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 1708 in turn includes communication circuitry 1726, storage 1722 and processing circuitry 1718. Either of control circuitry 1708 and 1734 may be utilized to execute or perform any or all the systems, methods, processes, and outputs of one or more of FIGS. 1-16, or any combination of steps thereof (e.g., as enabled by processing circuitries 1718 and 1736, respectively).

In addition to control circuitry 1708 and 1734, computing device 1702 and server 1704 may each include storage (storage 1722, and storage 1738, respectively). Each of storages 1722 and 1738 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1722 and 1738 may be used to store several types of content, metadata, and/or other types of data. Non-volatile memory may also be used (e.g., to launch a boot-up routine and other instructions). Cloud-based storage may be used to supplement storages 1722 and 1738 or instead of storages 1722 and 1738. In some embodiments, a user profile and messages corresponding to a chain of communication may be stored in one or more of storages 1722 and 1738. Each of storages 1722 and 1738 may be utilized to store commands, for example, such that when each of processing circuitries 1718 and 1736, respectively, are prompted through control circuitries 1708 and 1734, respectively. Either of processing circuitries 1718 or 1736 may execute any of the systems, methods, processes, and outputs of one or more of FIGS. 1-16, or any combination of steps thereof.

In some embodiments, control circuitry 1708 and/or 1734 executes instructions for an application stored in memory (e.g., storage 1722 and/or storage 1738). Specifically, control circuitry 1708 and/or 1734 may be instructed by the application to perform the functions discussed herein. In some embodiments, any action performed by control circuitry 1708 and/or 1734 may be based on instructions received from the application. For example, the application may be implemented as software or a set of and/or one or more executable instructions that may be stored in storage 1722 and/or 1738 and executed by control circuitry 1708 and/or 1734. The application may be a client/server application where only a client application resides on computing device 1702, and a server application resides on server 1704.

The application may be implemented using any suitable architecture. For example, it may be a stand-alone application wholly implemented on computing device 1702. In such an approach, instructions for the application are stored locally (e.g., in storage 1722), and data for use by the application is downloaded on a periodic basis (e.g., from an out-of-band feed, from an Internet resource, or using another suitable approach). Control circuitry 1708 may retrieve instructions for the application from storage 1722 and process the instructions to perform the functionality described herein. Based on the processed instructions, control circuitry 1708 may determine a type of action to perform based at least in part on input received from I/O circuitry 1712 or from communication network 1706.

The computing device 1702 is configured to communicate with an I/O device (not shown) via the I/O circuitry 1712. In some embodiments, the user input 1714 is received from the I/O device. A wired and/or wireless connection between the I/O circuitry 1712 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 1708 may include communication circuitry suitable for communicating with an application server (e.g., server 1704) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 1706). In another example of a client/server-based application, control circuitry 1708 runs a web browser that interprets web pages provided by a remote server (e.g., server 1704). For example, the remote server may store the instructions for the application in a storage device.

The remote server may process the stored instructions using circuitry (e.g., control circuitry 1734) and/or generate displays. Computing device 1702 may receive the displays generated by the remote server and may display the content of the displays locally via display 1710. For example, display 1710 may be utilized to present a string of characters. This way, the processing of the instructions is performed remotely (e.g., by server 1704) while the resulting displays, such as the display windows described elsewhere herein, are provided locally on computing device 1704. Computing device 1702 may receive inputs from the user via input/output circuitry 1712 and transmit those inputs to the remote server for processing and generating the corresponding displays.

Alternatively, computing device 1702 may receive inputs from the user via input/output circuitry 1712 and process and display the received inputs locally, by control circuitry 1708 and display 1710, respectively. For example, input/output circuitry 1712 may correspond to a keyboard and/or a set of and/or one or more speakers/microphones which are used to receive user inputs (e.g., input as displayed in a search bar or a display of FIG. 17 on a computing device). Input/output circuitry 1712 may also correspond to a communication link between display 1710 and control circuitry 1708 such that display 1710 updates based at least in part on inputs received via input/output circuitry 1712 (e.g., simultaneously update what is shown in display 1710 based on inputs received by generating corresponding outputs based on instructions stored in memory via a non-transitory, computer-readable medium).

Server 1704 and computing device 1702 may transmit and receive content and data such as media content via communication network 1706. For example, server 1704 may be a media content provider, and computing device 1702 may be a smart television configured to download or stream media content, such as a live news broadcast, from server 1704. Control circuitry 1734, 1708 may send and receive commands, requests, and other suitable data through communication network 1706 using communication circuitry 1732, 1726, respectively. Alternatively, control circuitry 1734, 1708 may communicate directly with each other using communication circuitry 1732, 1726, respectively, avoiding communication network 1706.

It is understood that computing device 1702 is not limited to the embodiments and methods shown and described herein. In nonlimiting examples, computing device 1702 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 1702 receives user input 1714 at input/output circuitry 1712. For example, computing device 1702 may receive a user input such as a user swipe or user touch. It is understood that computing device 1702 is not limited to the embodiments and methods shown and described herein.

User input 1714 may be received from a user selection-capturing interface that is separate from device 1702, such as a remote-control device, trackpad, or any other suitable user movement-sensitive, audio-sensitive or capture devices, or as part of device 1702, such as a touchscreen of display 1710. Transmission of user input 1714 to computing device 1702 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 1712 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 1718 may receive user input 1714 from input/output circuitry 1712 using communication path 1716. Processing circuitry 1718 may convert or translate the received user input 1714 that may be in the form of audio data, visual data, gestures, or movement to digital signals. In some embodiments, input/output circuitry 1712 performs the translation to digital signals. In some embodiments, processing circuitry 1718 (or processing circuitry 1736, as the case may be) conducts disclosed processes and methods.

Processing circuitry 1718 may provide requests to storage 1722 by communication path 1720. Storage 1722 may provide requested information to processing circuitry 1718 by communication path 1746. Storage 1722 may transfer a request for information to communication circuitry 1726 which may translate or encode the request for information to a format receivable by communication network 1706 before transferring the request for information by communication path 1728. Communication network 1706 may forward the translated or encoded request for information to communication circuitry 1732, by communication path 1730.

At communication circuitry 1732, the translated or encoded request for information, received through communication path 1730, is translated or decoded for processing circuitry 1736, which will provide a response to the request for information based on information available through control circuitry 1734 or storage 1738, or a combination thereof. The response to the request for information is then provided back to communication network 1706 by communication path 1740 in an encoded or translated format such that communication network 1706 forwards the encoded or translated response back to communication circuitry 1726 by communication path 1742.

At communication circuitry 1726, the encoded or translated response to the request for information may be provided directly back to processing circuitry 1718 by communication path 1754 or may be provided to storage 1722 through communication path 1744, which then provides the information to processing circuitry 1718 by communication path 1746. Processing circuitry 1718 may also provide a request for information directly to communication circuitry 1726 through communication path 1752, where storage 1722 responds to an information request (provided through communication path 1720 or 1744) by communication path 1724 or 1746 that storage 1722 does not contain information pertaining to the request from processing circuitry 1718.

Processing circuitry 1718 may process the response to the request received through communication paths 1746 or 1754 and may provide instructions to display 1710 for a notification to be provided to the users through communication path 1748. Display 1710 may incorporate a timer for providing the notification or may rely on inputs through input/output circuitry 1712 from the user, which are forwarded through processing circuitry 1718 through communication path 1748, to determine how long or in what format to provide the notification. When display 1710 determines the display has been completed, a notification may be provided to processing circuitry 1718 through communication path 1750.

The communication paths provided in FIG. 17 between computing device 1702, server 1704, communication network 1706, and all subcomponents depicted are examples and may be modified to reduce processing time or enhance processing capabilities for each step in the processes disclosed herein by one skilled in the art. Terminology

The terminology used herein is for the purpose of describing particular embodiments only and is not intended to be limiting of the disclosure.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

1. A method for control of polarization in social media, the method comprising:
receiving a social media post including textual information, wherein the social media post is associated with a first user account;
determining a first taxonomy of the textual information of the social media post associated with the first user account;
determining a second taxonomy for a second user account connected to the first user account;
comparing the first taxonomy of the textual information of the social media post associated with the first user account, the second taxonomy for the second user account connected to the first user account, and a predetermined condition; and
generating for output a response for the second user account connected to the first user account, the response having a third taxonomy similar to the second taxonomy based on the comparing.

2. The method of claim 1, wherein each of the first taxonomy, the second taxonomy, and the third taxonomy is scored.

3. The method of claim 1, wherein the determining the first taxonomy of the textual information of the social media post associated with the first user account includes:
utilizing a trained machine learning model trained to determine taxonomies of posts.

4. The method of claim 3, wherein the trained machine learning model is configured to receive a word vectorization of the textual information of the social media post, and to output a taxonomy vector, wherein each component of the taxonomy vector is associated with a score in a thematic category.

5. The method of claim 1, wherein the predetermined condition is based at least in part on a Euclidian distance between a first taxonomy vector of the first taxonomy and a second taxonomy vector of the second taxonomy exceeding a predetermined polarization threshold.

6. The method of claim 1, wherein the predetermined condition is based at least in part on a cosine similarity between a first taxonomy vector of the first taxonomy and a second taxonomy vector of the second taxonomy being less than a predetermined polarization threshold.

7. The method of claim 1, comprising selecting the second user account connected to the first user account from among a plurality of user accounts connected to the first user account, based at least in part on:
determining a subset of the second taxonomy for the second user account connected to the first user account, wherein the subset omits at least one component of the second taxonomy that corresponds to a position of the second user account on a subject other than a subject identified in the textual information of the social media post; and
comparing the first taxonomy of the textual information of the social media post associated with the first user account, and the subset of the second taxonomy for the second user account connected to the first user account.

8. The method of claim 1, wherein the comparing the first taxonomy of the textual information of the social media post associated with the first user account, the second taxonomy for the second user account connected to the first user account, and the predetermined condition further comprises:
determining whether a difference between the first taxonomy and the second taxonomy exceeds a predetermined polarization threshold;
based at least in part on determining the difference between the first taxonomy and the second taxonomy exceeds the predetermined polarization threshold, querying an artificial intelligence agent trained on a subject of the social media post and fine-tuned with data on positions differing from the first taxonomy to generate a plurality of artificial intelligence-assisted responses to the social media post;
ordering the plurality of the artificial intelligence-assisted responses by a similarity to the second taxonomy; and
selecting for presentation to the user the artificial intelligence-assisted response having a smallest distance or a closest similarity to the second taxonomy.

9. The method of claim 8, wherein the predetermined polarization threshold is defined by at least one of a social media platform providing the social media post or a user selectable setting of the second user account.

10. The method of claim 8, wherein the predetermined polarization threshold is defined by a machine learning model trained on engagement data from one or more social media posts having content associated with the first taxonomy or the second taxonomy.

11.-30. (canceled)

31. A system for control of polarization in social media, the system comprising:
input/output circuitry configured to:
receive a social media post including textual information, wherein the social media post is associated with a first user account; and
control circuitry configured to:
determine a first taxonomy of the textual information of the social media post associated with the first user account;
determine a second taxonomy for a second user account connected to the first user account;
compare the first taxonomy of the textual information of the social media post associated with the first user account, the second taxonomy for the second user account connected to the first user account, and a predetermined condition; and
generate for output an artificial intelligence-assisted response having a third taxonomy similar to the second taxonomy for the second user account connected to the first user account based on the comparing.

32. The system of claim 31, wherein each of the first taxonomy, the second taxonomy, and the third taxonomy is scored.

33. The system of claim 31, wherein the control circuitry configured to determine the first taxonomy of the textual information of the social media post associated with the first user account is configured to:
utilize a trained machine learning model trained to determine taxonomies of posts.

34. The system of claim 33, wherein the trained machine learning model is configured to receive a word vectorization of the textual information of the social media post, and to output a taxonomy vector, wherein each component of the taxonomy vector is associated with a score in a thematic category.

35. The system of claim 31, wherein the predetermined condition is based at least in part on a Euclidian distance between a first taxonomy vector of the first taxonomy and a second taxonomy vector of the second taxonomy exceeding a predetermined polarization threshold.

36. The system of claim 31, wherein the predetermined condition is based at least in part on a cosine similarity between a first taxonomy vector of the first taxonomy and a second taxonomy vector of the second taxonomy being less than a predetermined polarization threshold.

37. The system of claim 31, wherein the control circuitry is configured to select the second user account connected to the first user account from among a plurality of user accounts connected to the first user account, based at least in part on:
determining a subset of the second taxonomy for the second user account connected to the first user account, wherein the subset omits at least one component of the second taxonomy that corresponds to a position of the second user account on a subject other than a subject identified in the textual information of the social media post; and
comparing the first taxonomy of the textual information of the social media post associated with the first user account, and the subset of the second taxonomy for the second user account connected to the first user account.

38. The system of claim 31, wherein the control circuitry configured to compare the first taxonomy of the textual information of the social media post associated with the first user account, the second taxonomy for the second user account connected to the first user account, and the predetermined condition is configured to:
determine whether a difference between the first taxonomy and the second taxonomy exceeds a predetermined polarization threshold;
based at least in part on determining the difference between the first taxonomy and the second taxonomy exceeds the predetermined polarization threshold, query an artificial intelligence agent trained on a subject of the social media post and fine-tuned with data on positions differing from the first taxonomy to generate a plurality of artificial intelligence-assisted responses to the social media post;
order the plurality of the artificial intelligence-assisted responses by a similarity to the second taxonomy; and
select for presentation to the user the artificial intelligence-assisted response having a smallest distance or a closest similarity to the second taxonomy.

39. The system of claim 38, wherein the predetermined polarization threshold is defined by at least one of a social media platform providing the social media post or a user selectable setting of the second user account.

40. The system of claim 38, wherein the predetermined polarization threshold is defined by a machine learning model trained on engagement data from one or more social media posts having content associated with the first taxonomy or the second taxonomy.

41.-150. (canceled)
